(19) United States
(12) Patent Application Publication
(10) Pub. No.: US 2010/0184406 A1
(43) Pub. Date: Jul. 22, 2010

(54) Total Integrated Messaging

(76) Inventor: Michael Schrader, Plain City, OH (US)

Correspondence Address: Capitol City TechLaw, PLLC, 113 S. Columbus St., Suite 302, Alexandria, VA, 22314, US

(21) Appl. No.: 12/357,113

(22) Filed: Jan. 21, 2009

(51) Int. Cl. H04M 1/66; H04W 4/00; H04B 7/00; G10L 15/26

(52) U.S. Cl. 455/411; 455/466; 704/235; 455/41.2

(57) ABSTRACT

A messaging system may be integrated into a vehicle for electronically sending and receiving messages including textual content. The messages may be email, text messages, and/or instant messages. The messaging system may communicate, via a wireless transceiver, with a communication device located within the vehicle. The communication device may provide incoming messages to the messaging system and may receive outgoing messages from the messaging system for further transmission. The incoming messages may be presented visually or audibly to the occupant of the vehicle. A keyboard for providing textual input may be integrated with a steering wheel of the vehicle. The keyboard may be disabled when the vehicle is determined not to be moving less than a predetermined speed. The messaging system also may receive speech input which may be converted to text and sent to a recipient.

### BACKGROUND

1. Field of the Invention

The present teachings relate to systems or methods directed to providing a messaging capability integrated into a vehicle. Such methods may present a received message to an occupant of the vehicle and may send an outgoing message composed by the occupant of the vehicle, such that the occupant of the vehicle may not be distracted from driving the vehicle.

2. Discussion of the Related Art

Portable communication devices may be used to receive and send electronic messages having textual content, such as, for example, email and text messages. When operating a vehicle, a driver communicating via a portable communication device may be paying too much attention to composing and/or reading messages and too little attention to driving. As a result, a driver's probability of causing an accident, while communicating via the portable communication device, may be greatly increased.

One known communication system, which a driver may use, includes a wireless communication transceiver for communicating with an electronic communication device within a vehicle. The transceiver and the electronic communication device communicate with one another via a Bluetooth connection. The driver may provide input via text from the electronic communication device or by speaking. Output, based on received text, may be provided by synthesized speech via audio equipment within the vehicle. Using the electronic communication device, the driver may communicate with a recipient through email, a phone call, or a text message.

Another known vehicle communication system includes a car telephone with a small display and a navigation system with a display. The car telephone may transfer short text messages to the display of the navigation system. The text messages may be converted to speech and output over a speaker system.

A known hands-free telephone apparatus for use in vehicles answers telephone calls, converts a caller's voice to text, and prepares a summary of the text. The summary of the text may be output as synthesized speech. A heads-up display (HUD) may alert a user of an incoming call.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments of a messaging system integrated into a vehicle, a message including textual content may be wirelessly received from a portable communication device within a vehicle. The textual content may be displayed to an occupant of the vehicle via a heads-up display. In some embodiments, the textual content may be converted to generated speech and played to the occupant via a speaker or a hearing component, such as, for example, a headset.

The occupant of the vehicle may provide textual input to the messaging system via a QWERTY keyboard integrated with a steering wheel of the vehicle. In some embodiments, the steering wheel may include a cover for concealing the QWERTY keyboard. The keyboard may be disabled when the vehicle is determined not to be traveling less than a predetermined speed. The messaging system may wirelessly transmit an outgoing message to the portable communication device for further transmission to a recipient.

The messaging system may be capable of receiving speech input and converting the speech input to text, which may be processed as textual input for a message or as a command for the messaging system.

Further, the messaging system may be capable of operating in a privacy mode. During privacy mode, incoming messages may be presented only to the occupant of the vehicle.

The messaging system may send and receive messages as email, text messages, and/or instant messages.

### BRIEF DESCRIPTION OF THE DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an embodiment of an exemplary messaging system.

FIG. 2 is a functional block diagram of a processing device which may be used in an implementation of a messaging system.

FIG. 3 is a functional block diagram of components of an exemplary messaging system, which may be implemented by a processing device.

FIG. 4 illustrates an exemplary steering wheel having a keyboard integrated therein.

FIG. 5 illustrates an exemplary steering wheel with a cover for concealing an integrated keyboard.

FIGS. 6 and 7 illustrate, in more detail, the cover shown in FIG. 5.

FIGS. 8-10 show another embodiment of an exemplary steering wheel having a keyboard integrated therein.

FIG. 11 illustrates an exemplary keyboard, which may be integrated with a steering wheel.

FIGS. 12-16 are flowcharts of exemplary processes which may be performed in various embodiments.

### DETAILED DESCRIPTION

Overview

A messaging system, integrated into a vehicle, may be provided. The messaging system may permit an occupant of the vehicle to electronically communicate with a recipient at a remote location. Communications may be via email, text messages, and/or instant messages.

The messaging system may include a short-range wireless transceiver for communicating with a portable communication device within the vehicle. In some embodiments, the transceiver and the portable communication device may communicate via the Bluetooth® wireless protocol (Bluetooth is a registered trademark of Bluetooth Sig, Inc., of Bellevue, Wash.).

An incoming message, including text, may be received by the portable communication device. The portable communication device may wirelessly send the received incoming message to the messaging system. The wireless transceiver of the messaging system may receive the incoming message from portable communication device. The incoming message may be presented, either visually or audibly, to the occupant of the vehicle. In some embodiments, visually presenting the incoming message may include displaying textual content of the incoming message on a HUD of the vehicle. Audibly presenting the incoming message may include converting textual content of the incoming message to speech and playing the speech via a speaker or a hearing component, such as, for example, a headset.

The messaging system may include a keyboard, such as, for example, a QWERTY keyboard, integrated into a steering wheel of the vehicle. In some embodiments, the steering wheel may include a cover for concealing the keyboard. The occupant of the vehicle may provide input to the messaging system via the keyboard. In some embodiments, input from the keyboard may be enabled only when the vehicle is moving less than a predetermined speed, or is stationary. The keyboard may include respective buttons for performing functions. For example, selecting or depressing any one of the respective buttons may cause a corresponding function to be performed, such as, for example, composing of a message, replying to a message, sending a message, opening an address book, or another function.

The occupant may also provide input to the messaging system via speech. Inputted speech may be converted to text and may be further processed as would textual input.

Exemplary Messaging System

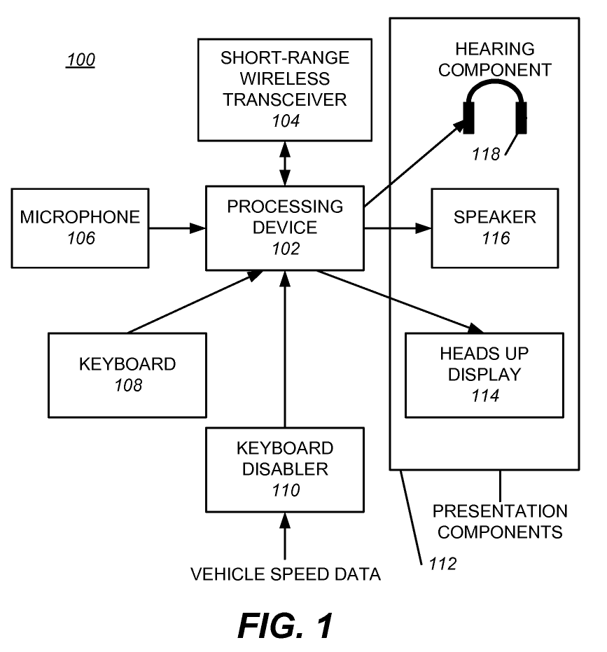

FIG. 1 illustrates an exemplary messaging system 100 which may be integrated into a vehicle. The messaging system 100 may include a processing device 102, a wireless transceiver 104, a microphone 106, a keyboard 108, a keyboard disabler 110, and presentation components 112. Presentation components 112 may include a heads-up display (HUD) 114, a speaker 116, and a hearing component 118.

Processing device 102 may process input received from various components and may provide output to components. Wireless transceiver 104 may receive incoming messages via a short-range wireless protocol from a portable communication device, and may transmit outgoing messages via the short-range wireless protocol to the portable communication device. In some embodiments, the short-range wireless protocol may include the Bluetooth® wireless communication protocol. Microphone 106 may provide speech input to processing device 102. Keyboard 108 may provide textual input, corresponding to selected or depressed keys of keyboard 108, to processing device 102. Keyboard disabler 110 may disable input from keyboard 108 when the vehicle is not moving less than a predetermined speed, such as, for example, 5 mph, or another suitable speed. Textual content of the messages may be displayed via HUD 114. Speech generated from the textual content of the messages may be played via speaker 116 or hearing component 118. In some embodiments, speaker 116 may be a speaker of an audio system of the vehicle, and hearing component 118 may be a wired, or wireless headset. The wireless headset may be a Bluetooth® headset or other type of wireless headset.

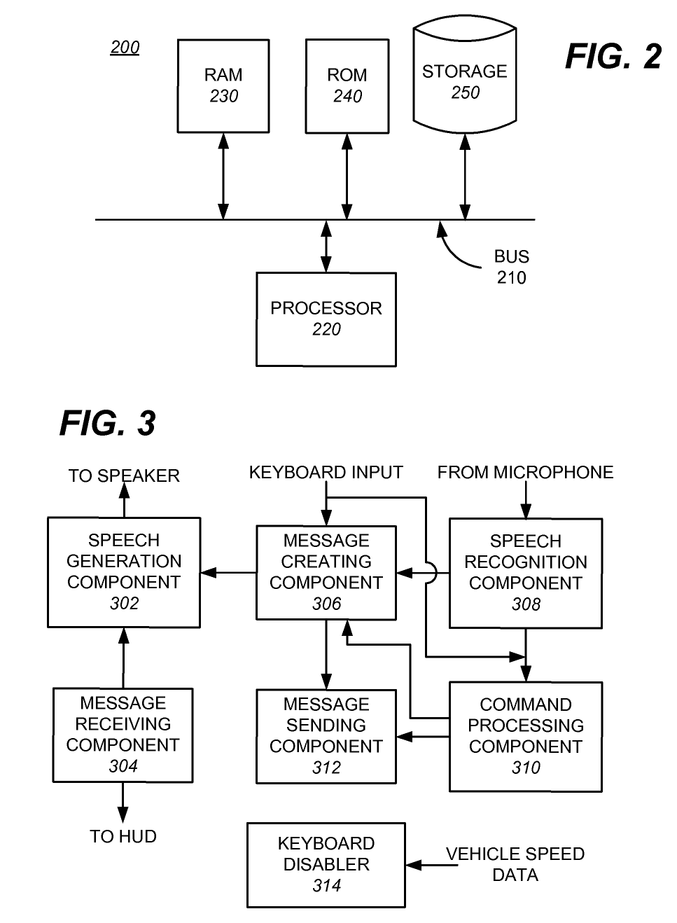

FIG. 2 is a functional block diagram of a processing device 200, which may implement processing device 102, in some embodiments. Processing device 200 may include processor 220, random access memory (RAM) 230, read only memory (ROM) 240, storage 250, and a bus 210 or other interface for permitting the aforementioned components to communicate with one another. Bus 210 may permit input components, such as, for example, wireless transceiver 104, microphone 106, keyboard 108, and keyboard disabler 110 to communicate with processor 220, and may also permit processor 220 to communicate with output components, such as, for example, wireless transceiver 104, HUD 114, speaker at 116, and hearing component 118.

Processor 220 may include at least one conventional processor or microprocessor that interprets and executes instructions. Memory may include RAM 230, ROM 240, another type of storage, or any combination thereof. RAM 230 may include a dynamic storage device for storing information and instructions for execution by processor 220. RAM 230 may also store temporary variables or other intermediate information used during execution of instructions by processor 220. ROM 240 may include a conventional ROM device or another type of static storage device that stores static information and instructions for processor 220. Storage device 250 may include a hard disk and a corresponding drive, or other type of storage device for storing information including, but not limited to, data and/or instructions for processor 220.

FIG. 3 is a functional block diagram of processing device 102 of messaging system of 100. Processing device 102 may include a speech generation component 302, a message receiving component 304, a message creating component 306, a speech recognition component 308, a command processing component 310, a message sending component 312, and a keyboard disabler 314.

Speech generation component 302 may generate speech based on textual input, such as, for example, textual input from a received message or textual input from a composed message. Speech generation component 302 may provide the generated speech to speaker 116 or hearing component 118.

Message receiving component 304 may receive an incoming message and may provide the incoming message to speech generation component 302 to produce generated speech or to HUD 114 to display.

Message creating component 306 may create a new message for an occupant of the vehicle to compose, or may create a new message for the occupant to compose for replying to a received message.

Speech recognition component 308 may receive speech input from microphone 106, may produce text based on the received speech input, and may provide the text to message creating component 306 or to command processing component 310 (when the received speech input is identified as a command). The received speech input may be identified as a command when the received speech includes a keyword, such as, for example, “send”, “delete”, “compose”, “reply”, or other keyword preceded by a pause of a least a predetermined duration. In other embodiments, other methods may be used to identify received speech input as a command.

Command processing component 310 may receive and process a recognized command, such as, for example, “send”, “delete”, “compose”, “reply”, or other command.

Message sending component 312 may send a message, such as, for example, a newly composed message, to a recipient.

Keyboard disabler 314 may receive vehicle speed data and, based on the received vehicle speed data, may disable keyboard input. For example, if keyboard disabler 314 determines, based on the vehicle speed data, that vehicle speed is not less than a predetermined vehicle speed, then keyboard disabler 314 may disable the keyboard input. The predetermined vehicle speed may be 5 mph or another suitable vehicle speed. Thus, if the vehicle speed is determined to be less than the predetermined vehicle speed, then the keyboard input may not be disabled.

Functional components illustrated in FIG. 3 are only exemplary. In other embodiments, processing device 102 may have additional, or other functional components. Further, the functional components may be implemented by hardware, software, firmware, or any combination thereof.

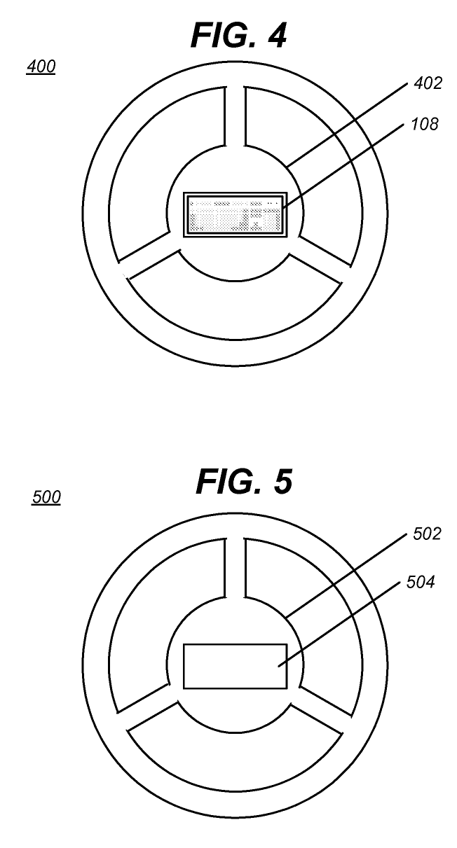

FIG. 4 illustrates an exemplary steering wheel 400 having a keyboard 108 embedded therein. Keyboard 108 may be embedded within a hub portion 402 of steering wheel 400. In some embodiments, keyboard 108 may only be functional when the vehicle is determined to be stationary or traveling at a speed less than a predetermined speed.

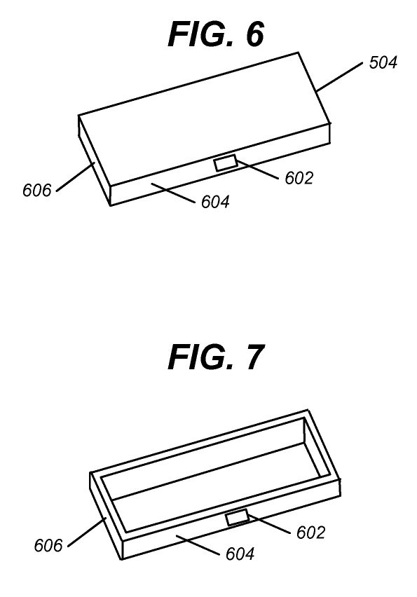

FIG. 5 illustrates another exemplary steering wheel 500 having a keyboard embedded therein and a removable cover 504 for concealing the keyboard. FIG. 6 illustrates a top perspective view of removable cover 504. As can be seen, a fastening member 602 may be mounted on a long narrow side 604 of removable cover 504. A second fastening member (not shown) may be mounted on a second long narrow side of removable cover 504, parallel to long narrow side 604. In some embodiments, a third fastening member (not shown) may be mounted on a short narrow side 606 of removable cover 504, which may be perpendicular to long narrow side 604 and the second long narrow side. A fourth fastening member (not shown) may be mounted on a second short narrow side (not shown), parallel to short narrow side 606 and perpendicular to long narrow side 604 and the second long narrow side.

The mounted fastening members may be any type of fastener, such as, for example, a magnet, or other fastener, which may be aligned with corresponding fastening receiving members (not shown) embedded within steering wheel 500. In an embodiment in which the mounted fastening members include magnets, the fastening receiving members may include a small thin plate of steel approximately a same size as the mounted fastening members. In other embodiments, the mounted fastening members may be small thin plates of steel and the fastening receiving members may include magnets. Of course, other types of fastening members and fastening receiving members may be used in other embodiments. FIG. 7 illustrates a bottom perspective view of removable cover 504. At least a portion of the keyboard may reside within a space formed by long narrow sides 604 and short narrow sides 606 when removable cover 504 is positioned to cover the keyboard.

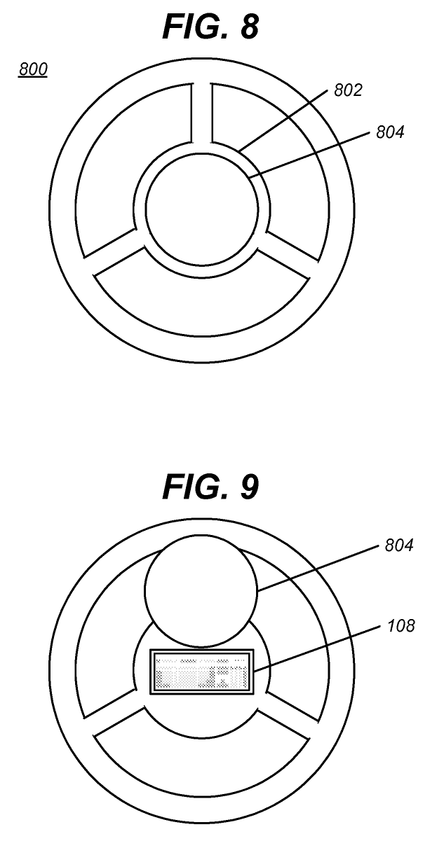

FIGS. 8 and 9 illustrate a third exemplary steering wheel 800, which may be used in various embodiments. Keyboard 108 may be embedded in a hub portion of steering wheel 800. In FIG. 8, cover 804 is positioned to hide, or conceal, keyboard 108. Cover 804 may be rotated, either clockwise or counterclockwise, to reveal keyboard 108, as shown in FIG. 9.

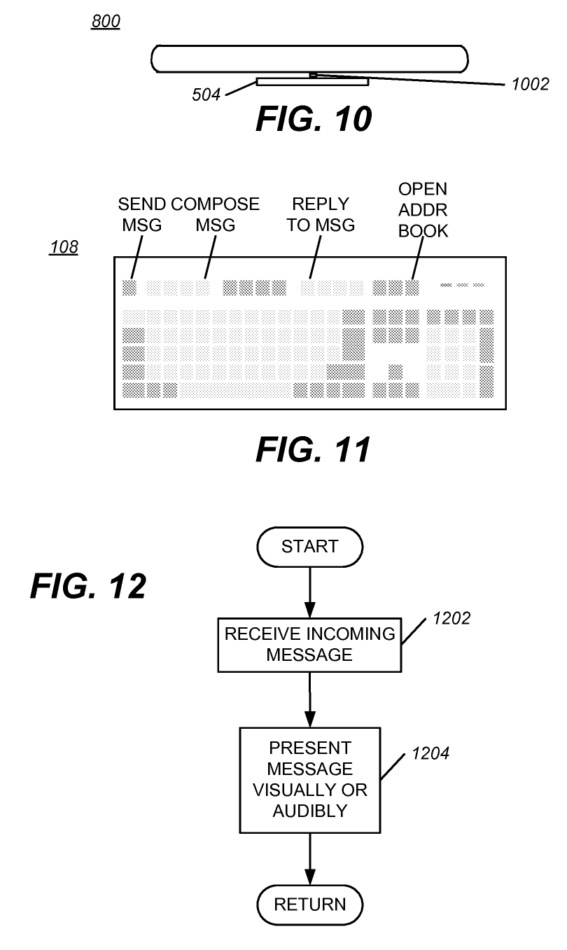

FIG. 10 illustrates a top view of steering wheel 800 and cover 804. Cover 804 may be rotatably attached to steering wheel 800 via a pivoting member 1002.

FIG. 11 illustrates a more detailed view of keyboard 108. Keyboard 108 may be a QWERTY keyboard for entering textual input. Keyboard 108 may include one or more respective single keys for performing corresponding functions when selected or depressed. The corresponding functions may include sending of a message, composing a message, replying to a message, and opening an address book. In other embodiments, the corresponding functions may include additional, or different functions.

Exemplary Processes

FIG. 12 is a flowchart illustrating an exemplary processing which may be performed in various embodiments. The process may begin by message receiving component 304 of processing device 102 receiving, from a portable communication device via wireless transceiver 104, an incoming message having textual content (act 1202). The received incoming message may be presented visually, via a display, such as, for example, HUD 114, or audibly, via speaker 116 or hearing component 118 (act 1204).

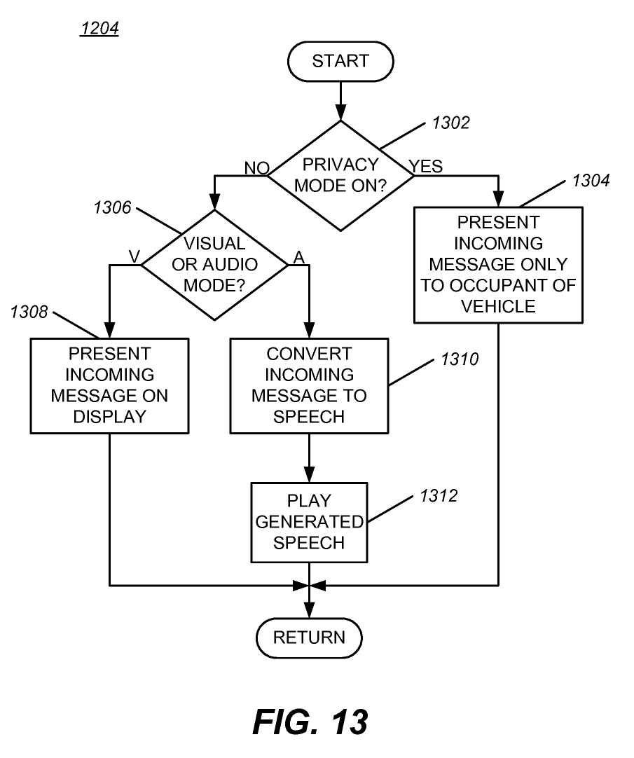

FIG. 13 is a flowchart illustrating an exemplary process for performing act 1204 of FIG. 12. The process may begin by message receiving component 304 determining whether privacy mode is on (act 1302). If privacy mode is determined to be on, then the incoming message may be presented only to the occupant of a vehicle, such as, for example, a driver of the vehicle (act 1304). In some embodiments, presenting the incoming message only to the occupant of the vehicle may include generating speech from textual content of the incoming message and playing the generated speech to the occupant via hearing component 118. Hearing component 118 may include a wired headset or wireless headset including, but not limited to, a Bluetooth® headset.

If, during act 1302, the privacy mode is determined not to be on, then a determination may be made regarding whether the messaging system is operating in a visual mode or an audio mode (act 1306). If the messaging system is determined to be operating in visual mode, then message receiving component 304 may present the received incoming message via HUD 114 or another display device (act 1308).

If, during act 1306 the messaging system is determined to be operating in audio mode, speech recognition component 308 may generate speech based on textual content of the incoming message (act 1310). The messaging system then may play the generated speech via speaker 116 or hearing component 118.

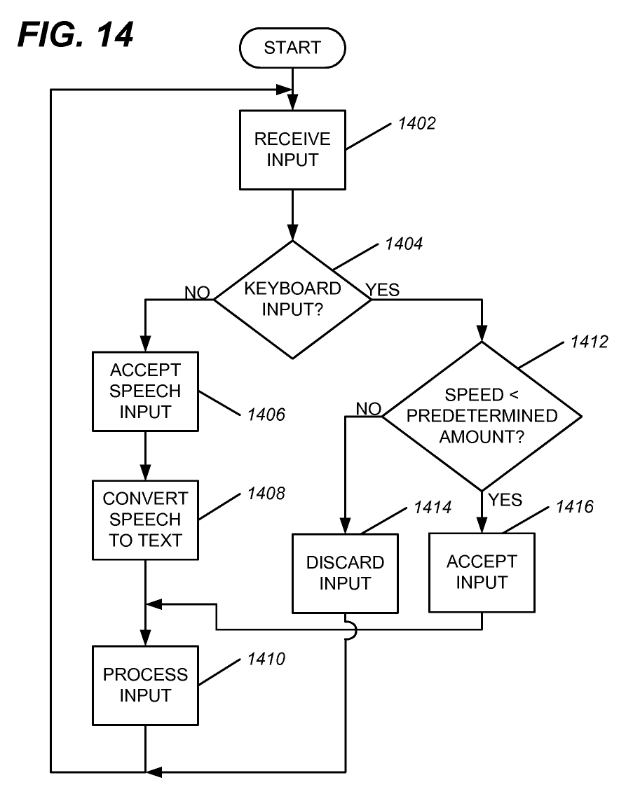

FIG. 14 is a flowchart illustrating an exemplary processing with respect to receiving input from the occupant of the vehicle in an exemplary messaging system. The process may begin by receiving input from the occupant (act 1402). A determination may be made regarding whether or not the received input is keyboard input (act 1404). If the received input is determined not to be keyboard input, then the received input is assumed to be speech input and the speech input may be accepted (act 1406). A speech recognition component 308 may then recognize the received speech input and may convert the speech input to text (act 1408). The text then may be processed as a command or as textual input for a message (act 1410). Act 1402 again may be performed.

If, during act 1404, the received input is determined to be keyboard input, then keyboard disabler 314 may determine whether the vehicle is traveling less than a predetermined speed, based on vehicle speed data (act 1412). If keyboard disabler 314 determines that the vehicle is not traveling less than the predetermined speed, then keyboard disabler 314 may cause the received input to be discarded (act 1414). Otherwise, the received input may be accepted (act 1416) and processed (act 1410).

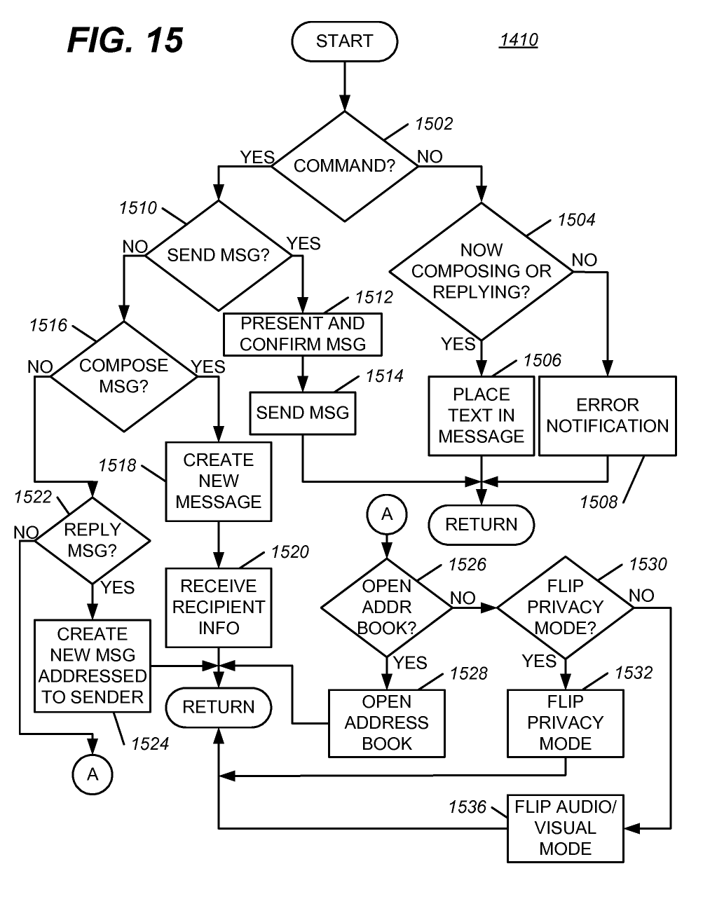

FIG. 15 is a flowchart illustrating exemplary processing which may be performed during act 1410 in various embodiments. The process may begin by determining whether received input is a command (act 1502). In some embodiments, a command may be indicated by one or more keywords occurring at a beginning of the received input. In other embodiments, other methods may be employed to determine whether the received input is a command.

If the received input is determined not to be a command, then a determination may be made regarding whether a new message or a reply message is now being composed (act 1504). If a new message or a reply message is now being composed, then text from the received input may be placed into the new message or the reply message (acts 1506). Otherwise, an error notification may be presented to the occupant (acts 1508).

If, during act 1502, the received input is determined to be a command, then command processing component 310 may determine whether the command is a “send message” command (act 1510). If the command is determined to be a “send message” command, then a message to be sent may be presented to the occupant for confirmation (act 1512). The message may be presented via a display, such as, for example, HUD 114, or other display, or the message may be presented via speaker 116 or hearing component 118. After the occupant confirms the message, via speech input or keyboard 108, message sending component 312 may send the message to a nearby portable device via wireless transceiver 104 (act 1514).

If, during act 1510, the received command is determined not to be a “send message” command, then command processing component 310 may determine whether the received command is a “compose message” command (act 1516). If the received command is determined to be a “compose message” command, then message creating component 306 may create a new message (act 1518) and recipient information may be received (act 1520). The recipient information may be an indication of a particular recipient, such as, for example, a recipient's name or a recipient's address (for example, an email address, a telephone number, or other type of address).

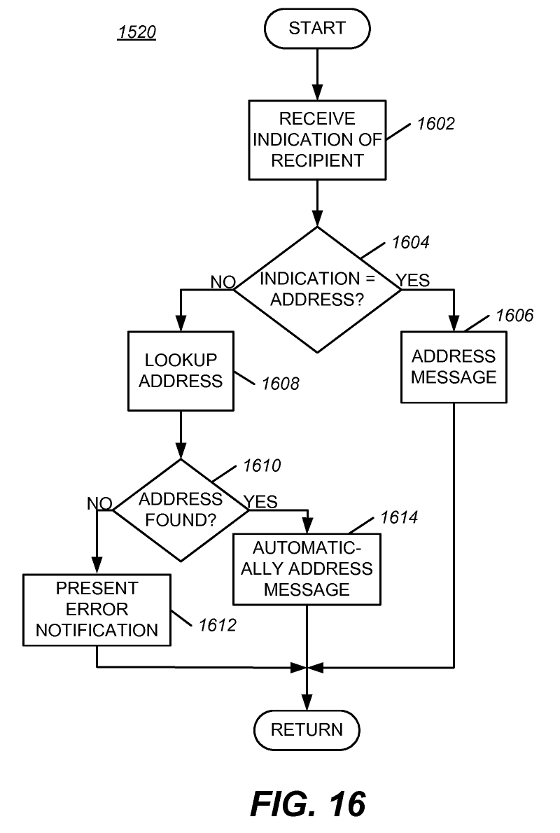

FIG. 16 is a flowchart illustrating exemplary processing with respect to act 1520. This process may begin with receiving an indication of a particular recipient (act 1602). A determination may then be made regarding whether the received indication is an address (act 1604). If the indication is determined to be an address, then the message may be addressed using the received indication (act 1606).

If, during act 1604, the received indication is determined not to be an address, then the indication may be used to search for an address in an address book (act 1610). For example, the indication may be a recipient's name, which may be found in the address book. If the address of the recipient is found in the address book, then the message may be automatically addressed using the found address (act 1614).

If, during act 1610, an address corresponding to the received indication is not found, then an error notification may be presented to the occupant of the vehicle (act 1612).

Returning to FIG. 15, if, during act 1516, the received command is determined not to be a “compose message” command, then command processing component 310 may determine whether the received command is a “reply to message” command (act 1522). If the received command is determined to be a “reply to message” command, then a new message may be created addressed to a sender of a current received message (act 1524).

If, during act 1522, the received command is determined not to be a “reply to message” command, then command processing component 310 may determine whether the received command is an “open address book” command (act 1526). If the command is determined to be an “open address book” command, then the address book may be opened (act 1528). Otherwise, a determination may be made regarding whether the received command is a “flip privacy mode” command (act 1530). If the command is determined to be a “flip privacy mode” command, then command processing component 310 may flip the privacy mode of the messaging system (act 1532). For example, if the privacy mode is on, flipping the privacy mode turns the privacy mode off. Similarly, if the privacy mode is off, flipping the privacy mode turns the privacy mode on.

If, during act 1530, the received command is determined not to be a “flip privacy mode” command, then the command may be assumed to be a flip audio/visual mode command and the audio/visual mode may be flipped (act 1536). For example, if the audio/visual mode is set to audio, flipping the audio/visual mode may set the audio/visual mode to visual. Similarly, if the audio/visual mode is set to visual, flipping the audio/visual mode may set the audio/visual mode to audio.

Conclusion

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not be construed as limiting the claims in any way. Other configurations of the described embodiments are part of the scope of this disclosure. For example, other methods may be employed by keyboard disabler 110 to determine whether to disable input from keyboard 108. In addition, acts illustrated by the flowcharts of FIGS. 12-16 may be performed in a different order in other embodiments, and may include additional or fewer acts. Further, in other embodiments, other devices or components may perform portions of the acts described above. Accordingly, the appended claims and their legal equivalents define the invention, rather than any specific examples given.

I claim as my invention:

1. A method for an occupant of a vehicle to electronically communicate messages including text, the method comprising:
wirelessly receiving a message, including text, from a portable communication device within the vehicle, the message being wirelessly received by a messaging system integrated into the vehicle;
displaying the text from the message to the occupant of the vehicle via a heads up display;
receiving textual input for a second message via a QWERTY keyboard integrated with a steering wheel of the vehicle; and
wirelessly transmitting the second message to the portable communication device located within the vehicle for further transmission to a recipient.

2. The method of claim 1, wherein
the QWERTY keyboard is operational only when the vehicle is stationary or travelling at a speed less than a predetermined speed.

3. The method of claim 1, wherein the steering wheel includes a cover for concealing the QWERTY keyboard.

4. The method of claim 1, further comprising:
receiving speech input from the occupant of the vehicle;
converting the speech input to text;
including the text from the converted speech input into an outgoing message; and
wirelessly sending the outgoing message to the portable communication device within the vehicle for further transmission of the outgoing message.

5. The method of claim 4, further comprising:
presenting the outgoing message to the occupant of the vehicle, the presenting occurring by displaying the text included in the outgoing message via the heads up display, or by audibly generating speech based on the text of the outgoing message; and
receiving a confirmation from the occupant of the vehicle, wherein
the wireless sending of the outgoing message is performed after the receiving of the confirmation.

6. The method of claim 5, wherein the received confirmation is provided via speech input or via the QWERTY keyboard.

7. The method of claim 1, further comprising:
converting the message to generated speech; and
playing the generated speech to the occupant of the vehicle.

8. The method of claim 1, further comprising:
receiving input, from the occupant of the vehicle, indicating a desire for a privacy mode of operation with respect to the messaging system, wherein
when an incoming message is received by the messaging system operating in the privacy mode, contents of the incoming message are presented only to the occupant of the vehicle.

9. The method of claim 1, further comprising:
receiving an indication of a recipient of the second message;
looking up a recipient address corresponding to the received indication; and
addressing the second message to the recipient by using the looked up recipient address.

10. A messaging system integrated within a vehicle, the messaging system comprising:
a short-range wireless transceiver to wirelessly communicate messages, including textual content, to and from a portable communication device located within the vehicle;
a QWERTY keyboard to provide textual input for a message, the QWERTY keyboard being integrated with a steering wheel of the vehicle; and
a presentation component to present textual content of an incoming message or textual content of an outgoing message to an occupant of the vehicle.

11. The messaging system of claim 10, wherein the steering wheel includes a removable cover, such that when the cover is attached to the steering wheel, the QWERTY keyboard is hidden from view.

12. The messaging system of claim 10, further comprising:
a keyboard disabler connected to a speed monitoring component, the keyboard disabler being for disabling the QWERTY keyboard when the speed monitoring component provides vehicle speed data to the keyboard disabler indicating that the vehicle is not moving less than a predetermined speed.

13. The messaging system of claim 10, wherein the presentation component includes a heads up display for displaying the textual content of the incoming message or the outgoing message.

14. The messaging system of claim 10, further comprising:
a speech recognition component for converting speech input to text.

15. The messaging system of claim 10, wherein the presentation component includes a speaker or a hearing component for playing generated speech based on the textual content of the incoming message or the textual content of the outgoing message.

16. The messaging system of claim 15, wherein the QWERTY keyboard includes a button for enabling a privacy mode of operation of the messaging system.

17. The messaging system of claim 16, wherein when the messaging system operates in the privacy mode, the generated speech is provided only to the occupant of the vehicle via a headset.

18. The messaging system of claim 10, wherein the QWERTY keyboard includes respective single buttons, such that a corresponding one of a plurality of functions is performed when a respective one of the single buttons is selected, the plurality of functions including sending a message, composing a message, replying to a message, and opening an address book.

19. The messaging system of claim 10, wherein the messages include a text message, an email message, or an instant message.

20. The messaging system of claim 10, wherein the short-range wireless transceiver includes a Bluetooth transceiver.
